(19) United States
(12) Patent Application Publication
(10) Pub. No.: US 2008/0000874 A1
(43) Pub. Date: Jan. 3, 2008

(54) Printed wiring board and method of manufacturing the same

(75) Inventor: Takahiro Nakano, Kyoto (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/822,200

(22) Filed: Jul. 3, 2007

(30) Foreign Application Priority Data
Jul. 3, 2006 (JP) 2006-186152

(51) Int. Cl. H01B 13/00

(52) U.S. Cl. 216/13; 216/18

(57) ABSTRACT

A multilayer printed wiring board (1) in which conductor wiring layers (12, 14a, 14b) and interlayer insulating resin layers (13) are alternately stacked on both sides of a core substrate (11) and the outermost conductor wiring layer is covered with a surface insulating resin layer (16), wherein in a mounting area (10) of a semiconductor device, the surface insulating resin layer (16) formed on the interlayer insulating resin layer (13) is removed like a quadrilateral in an area other than the conductor lands (14a) and immediately below the semiconductor device to leave a removed portion (17) at the center of the mounting area (10), the conductor lands (14a) being bonded to external electrodes of the semiconductor device.

### FIELD OF THE INVENTION

The present invention relates to a printed wiring board and a method of manufacturing the same.

### BACKGROUND OF THE INVENTION

In recent years, densities in packaging technology for semiconductor devices have increased in response to electronic equipment having been reduced in size and thickness with higher performance. Inevitably, printed wiring boards have been reduced in size and thickness and the number of layers in printed wiring boards has increased. Further, lead-free solder has become available and the height and amount of solder supplied to mounting lands (solder joints) have been reduced. For these reasons, warpage of a printed wiring board seriously affects the quality and reliability of a mounting operation, so that more problems have occurred due to warping of printed wiring boards.

Thus in the conventional art, in order to reduce an amount of warpage over an printed wring board, the ratio of wiring layer formation areas on an outer end and an inner end of the printed wiring board is optimized to further balance warpage on the outer end and the inner end (e.g., see Japanese Patent Laid-Open No. 59-202681). Moreover, a dummy wiring layer is provided on the outer end of a printed wiring board to increase the stiffness and so on of the overall printed wiring board (e.g., see Japanese Patent Laid-Open No. 2002-76530).

In other manufacturing methods, a pressure is applied with rollers, a heating method is optimized, and other measures are taken to reduce warpage on overall printed wiring boards.

The following will describe the configuration of the mounting area of a semiconductor device on a conventional printed wiring board with reference to the accompanying drawings.

FIGS. 10A, 10B, 11A and 11B show mounting areas 100 of semiconductor devices of surface mount lead type typified by QFP and QFN and show an example of a four-layer board. In such a semiconductor device, conductor wiring layers (inner layers) 102 are provided on both sides of a core substrate 101, interlayer insulating resin layers 103 are formed thereon to cover the conductor wiring layers 102, and conductor wiring layers (outer layers) 104b and conductor lands 104a for mounting (soldering and the like) the semiconductor device are provided thereon. Surface insulating resin layers 105 are provided as the outermost surfaces.

In the semiconductor device shown in FIGS. 10A and 10B, the surface insulating resin layers 105 are evenly and flatly formed, in the mounting area 100, over an area other than the conductor lands 104a and immediately below the semiconductor device.

Further, in the semiconductor device shown in FIGS. 11A and 11B, the conductor wiring layers 104b for dissipating heat, improving electrical characteristics, and obtaining stiffness are formed, in the mounting area 100, over an area other than the conductor lands 104a and immediately below the semiconductor device. Moreover, the surface insulating resin layers 105 are evenly and flatly formed over the conductor wiring layers 104b.

As described above, in the conventional art, although measures against warpage have been taken on overall printed wiring boards, no measures are taken on the mounting areas of semiconductor devices in the existing circumstances, and it is considered that warpage in the mounting areas of semiconductor devices can be inevitably reduced by reducing warpage on overall printed wiring boards.

However, problems in mounting are increasingly caused by warping (expansion) of the outermost (outside) surface insulating resin layer (solder resist) in the mounting area of each semiconductor device, not by warping of an overall printing wiring board. For example, in the mounting of surface mount devices of QFP, SOP and QFN or surface mount devices of BGA, LGA and so on having external electrodes only on the outer ends, a surface insulating resin layer formed immediately below each semiconductor device is warped (expanded) by about 100 μm due to heat (200° C. or higher) during reflow and is contacted to the backside of the semiconductor device, so that the semiconductor device is raised and a connection circuit is opened. Alternatively, strength becomes insufficient and reliability decreases in mounting. Particularly in an area on which a large surface insulating resin layer is evenly and flatly formed, such problems frequently occur.

### DISCLOSURE OF THE INVENTION

An object of the present invention is to provide a printed wiring board and a method of manufacturing the same which can prevent a surface insulating resin layer from being warped (expanded) during reflow in an area for mounting each semiconductor device on the printed wiring board and can improve yields and the quality and reliability of a mounting operation.

In order to attain the object, a first invention is a printed wiring board having one of a single-layer structure and a multi-layer structure in which a conductor wiring layer and an interlayer insulating resin layer are stacked or alternately stacked on at least one side of a core substrate and the outermost conductor wiring layer is covered with a surface insulating resin layer,

wherein in an area for mounting a semiconductor device, a part of the surface insulating resin layer formed on one of the interlayer insulating resin layer and the conductor wiring layer is removed in an area other than conductor land portions and immediately below the semiconductor device, the conductor land portions being bonded to the external electrodes of the semiconductor device.

Further, in the printed wiring board, the conductor wiring layer other than the conductor land portions formed in the area immediately below the semiconductor device is dummy wiring not electrically connected to the conductor land portions.

Moreover, a method of manufacturing the wiring board includes the steps: obtaining a conductor wiring layer by forming a wiring pattern on a conductor layer provided on at least one side of a core substrate; and forming a surface insulating resin layer on the outermost conductor wiring layer after repeatedly performing a predetermined number of times the steps of forming an interlayer insulating resin layer so as to cover the conductor wiring layer and forming a conductor wiring layer on the interlayer insulating resin layer,

wherein the method further includes the step of forming, in an area for mounting a semiconductor device, the surface insulating resin layer and removing a part of the surface insulating resin layer in an area other than conductor land portions and immediately below the semiconductor device, the conductor land portions being bonded to the external electrodes of the semiconductor device.

A second invention is a printed wiring board having one of a single-layer structure and a multilayer structure in which a conductor wiring layer and an interlayer insulating resin layer are stacked or alternately stacked on at least one side of a core substrate and the outermost conductor wiring layer is covered with a surface insulating resin layer,

wherein in an area for mounting a semiconductor device, a part of the outermost conductor wiring layer is removed in an area other than conductor land portions and immediately below the semiconductor device, the conductor land portions being bonded to the external electrodes of the semiconductor device.

Moreover, in the wiring board, the conductor wiring layer other than the conductor land portions formed in the area immediately below the semiconductor device is dummy wiring not electrically connected to the conductor land portions.

Further, the surface insulating resin layer is recessed on the area on which the part of the conductor wiring layer is removed.

Moreover, a method of manufacturing the wiring board includes the steps of: obtaining a conductor wiring layer by forming a wiring pattern on a conductor layer provided on at least one side of a core substrate; and forming a surface insulating resin layer on the outermost conductor wiring layer after repeatedly performing a predetermined number of times the steps of forming an interlayer insulating resin layer so as to cover the conductor wiring layer and forming a conductor wiring layer on the interlayer insulating resin layer,

wherein the method further includes the step of forming, in an area for mounting a semiconductor device, the outermost conductor wiring layer and removing a part of the outermost conductor wiring layer in an area other than conductor land portions and immediately below the semiconductor device, the conductor land portions being bonded to the external electrodes of the semiconductor device.

A third invention is a printed wiring board having one of a single-layer structure and a multilayer structure in which a conductor wiring layer and an interlayer insulating resin layer are stacked or alternately stacked on at least one side of a core substrate and the outermost conductor wiring layer is covered with a surface insulating resin layer,

wherein in an area for mounting a semiconductor device, a part of the surface insulating resin layer formed on one of the interlayer insulating resin layer and the conductor wiring layer and a part of the outermost conductor wiring layer are removed in an area other than conductor land portions and immediately below the semiconductor device, the conductor land portions being bonded to the external electrodes of the semiconductor device.

Moreover, in the wiring board, the conductor wiring layer other than the conductor land portions formed in the area immediately below the semiconductor device is dummy wiring not electrically connected to the conductor land portions.

Further, the surface insulating resin layer is recessed on the area on which the part of the conductor wiring layer is removed.

Moreover, a method of manufacturing the printed board includes the steps of: obtaining a conductor wiring layer by forming a wiring pattern on a conductor layer provided on at least one side of a core substrate; and forming a surface insulating resin layer on the outermost conductor wiring layer after repeatedly performing a predetermined number of times the steps of forming an interlayer insulating resin layer so as to cover the conductor wiring layer and forming a conductor wiring layer on the interlayer insulating resin layer,

wherein the method further includes the steps of: forming, in an area for mounting a semiconductor device, the surface insulating resin layer and removing a part of the surface insulating resin layer in an area other than conductor land portions and immediately below the semiconductor device, the conductor land portions being bonded to the external electrodes of the semiconductor device; and forming the outermost conductor wiring layer and removing a part of the outermost conductor wiring layer.

A fourth invention is a printed wiring board having one of a single-layer structure and a multilayer structure in which a conductor wiring layer and an interlayer insulating resin layer are stacked or alternately stacked on at least one side of a core substrate and the outermost conductor wiring layer is covered with a surface insulating resin layer,

wherein in an area for mounting a semiconductor device, ones of a plurality of through holes and a plurality of via holes are formed in an area other than conductor land portions and immediately below the semiconductor device, the conductor land portions being bonded to the external electrodes of the semiconductor device.

Moreover, in the wiring board, one of the through hole and the via hole is dummy wiring not electrically connected to the conductor land portions.

Moreover, a method of manufacturing the wiring board includes the steps of: obtaining a conductor wiring layer by forming a wiring pattern on a conductor layer provided on at least one side of a core substrate; and forming a surface insulating resin layer on the outermost conductor wiring layer after repeatedly performing a predetermined number of times the steps of forming an interlayer insulating resin layer so as to cover the conductor wiring layer and forming a conductor wiring layer on the interlayer insulating resin layer,

wherein the method further includes the step of forming, in an area for mounting a semiconductor device, one of a through hole and a via hole in an area other than conductor land portions and immediately below the semiconductor device before the step of forming the surface insulating resin layer, the conductor land portions being bonded to the external electrodes of the semiconductor device.

A fifth invention is a printed wiring board having one of a single-layer structure and a multilayer structure in which a conductor wiring layer and an interlayer insulating resin layer are stacked or alternately stacked on at least one side of a core substrate and the outermost conductor wiring layer is covered with a first surface insulating resin layer,

wherein in an area for mounting a semiconductor device, a second surface insulating resin layer is formed on the first surface insulating resin layer in an area other than conductor land portions and immediately below the semiconductor device, the conductor land portions being bonded to the external electrodes of the semiconductor device.

Moreover, in the wiring board, the second surface insulating resin layer has a lower coefficient of thermal expansion than the first surface insulating resin layer.

Moreover, a method of manufacturing the wiring board includes the steps of: obtaining a conductor wiring layer by forming a wiring pattern on a conductor layer provided on at least one side of a core substrate; and forming a first surface insulating resin layer on the outermost conductor wiring layer after repeatedly performing a predetermined number of times the steps of forming an interlayer insulating resin layer so as to cover the conductor wiring layer and forming a conductor wiring layer on the interlayer insulating resin layer,

wherein the method further includes the step of forming, in an area for mounting a semiconductor device, a second surface insulating resin layer on the first surface insulating resin layer in an area other than conductor land portions and immediately below the semiconductor device, the conductor land portions being bonded to the external electrodes of the semiconductor device.

A sixth invention is a printed wiring board having one of a single-layer structure and a multilayer structure in which a conductor wiring layer and an interlayer insulating resin layer are stacked or alternately stacked on at least one side of a core substrate and the outermost conductor wiring layer is covered with a first surface insulating resin layer,

wherein in an area for mounting a semiconductor device, a part of the first surface insulating resin layer is removed and a second surface insulating resin layer is formed on the removed part in an area other than conductor land portions and immediately below the semiconductor device, the conductor land portions being bonded to the external electrodes of the semiconductor device.

Moreover, in the wiring board, the second surface insulating resin layer has a lower coefficient of thermal expansion than the first surface insulating resin layer.

Moreover, a method of manufacturing the wiring board includes the steps of: obtaining a conductor wiring layer by forming a wiring pattern on a conductor layer provided on at least one side of a core substrate; and forming a first surface insulating resin layer on the outermost conductor wiring layer after repeatedly performing a predetermined number of times the steps of forming an interlayer insulating resin layer so as to cover the conductor wiring layer and forming a conductor wiring layer on the interlayer insulating resin layer,

wherein the method further includes the step of forming, in an area for mounting a semiconductor device, the first surface insulating resin layer, removing a part of the first surface insulating resin layer, and forming a second surface insulating resin layer on the removed part in an area other than conductor land portions and immediately below the semiconductor device, the conductor land portions being bonded to the external electrodes of the semiconductor device.

According to the printed wiring boards and the methods of manufacturing the same, in the mounting area of each semiconductor device, the area of the surface insulating resin layer is reduced or divided. Alternatively, the area of the outermost conductor wiring layer is reduced and recessed portions are provided on the surface insulating resin layer disposed on the conductor wiring layer, so that the same effect as the divided surface insulating resin layer can be obtained. It is thus possible to suppress an amount of expansion of the surface insulating resin layer on each part during reflow heating, improving yields and the quality and reliability of a mounting operation.

Also in the case where the through holes or via holes are formed and in the case where the second surface insulating resin layer having a low coefficient of thermal expansion is formed on the first surface insulating resin layer, the same effect can be obtained, that is, it is possible to suppress an amount of expansion of the surface insulating resin layer on each part during reflow heating.

A variety of characteristics and effects of the present invention will become more apparent from preferred embodiments about to be described with reference to the accompanying drawing, in which:

### BRIEF DESCRIPTION OF THE DRAWINGS

FIG. 1A is a plan view showing a printed wiring board according to First Embodiment of the present invention;

FIG. 1B is a sectional view taken along line A-A of FIG. 1A;

FIG. 2A is a plan view showing a printed wiring board according to Second Embodiment of the present invention;

FIG. 2B is a sectional view taken along line B-B of FIG. 2A;

FIG. 3A is a plan view showing a printed wiring board according to Third Embodiment of the present invention;

FIG. 3B is a sectional view taken along line C-C of FIG. 3A;

FIG. 4A is a plan view showing a printed wiring board according to Fourth Embodiment of the present invention;

FIG. 4B is a sectional view taken along line D-D of FIG. 4A;

FIG. 5A is a plan view showing a printed wiring board according to Fifth Embodiment of the present invention;

FIG. 5B is a sectional view taken along line E-E of FIG. 5A;

FIG. 6A is a plan view showing a printed wiring board according to Sixth Embodiment of the present invention;

FIG. 6B is a sectional view taken along line F-F of FIG. 6A;

FIG. 7A is a plan view showing a printed wiring board according to Seventh Embodiment of the present invention;

FIG. 7B is a sectional view taken along line G-G of FIG. 7A;

FIG. 8A is a plan view showing a printed wiring board according to Eighth Embodiment of the present invention;

FIG. 8B is a sectional view taken along line H-H of FIG. 8A;

FIG. 9A is a sectional view showing a method of manufacturing a printed wiring board according to Sixth Embodiment of the present invention;

FIG. 9B is a sectional view showing the method of manufacturing the printed wiring board according to Sixth Embodiment of the present invention;

FIG. 9C is a sectional view showing the method of manufacturing the printed wiring board according to Sixth Embodiment of the present invention;

FIG. 9D is a sectional view showing the method of manufacturing the printed wiring board according to Sixth Embodiment of the present invention;

FIG. 9E is a sectional view showing the method of manufacturing the printed wiring board according to Sixth Embodiment of the present invention;

FIG. 9F is a sectional view showing the method of manufacturing the printed wiring board according to Sixth Embodiment of the present invention;

FIG. 10A is a plan view showing a printed wiring board according to a conventional example;

FIG. 10B is a sectional view taken along line I-I of FIG. 10A;

FIG. 11A is a plan view showing a printed wiring board according to a conventional example; and

FIG. 11B is a sectional view taken along line J-J of FIG. 11A.

### DESCRIPTION OF THE EMBODIMENTS

The following will describe a printed wiring board according to preferred embodiments of the present invention and embodiments of a method of manufacturing the same with reference to the accompanying drawings.

The drawings used in the following explanation show the main part of the printed wiring board, that is, a mounting area for mounting a semiconductor device.

### First Embodiment

A printed wiring board and a method of manufacturing the same will be described below according to First Embodiment of the present invention (corresponding to claim 1 and claim 15).

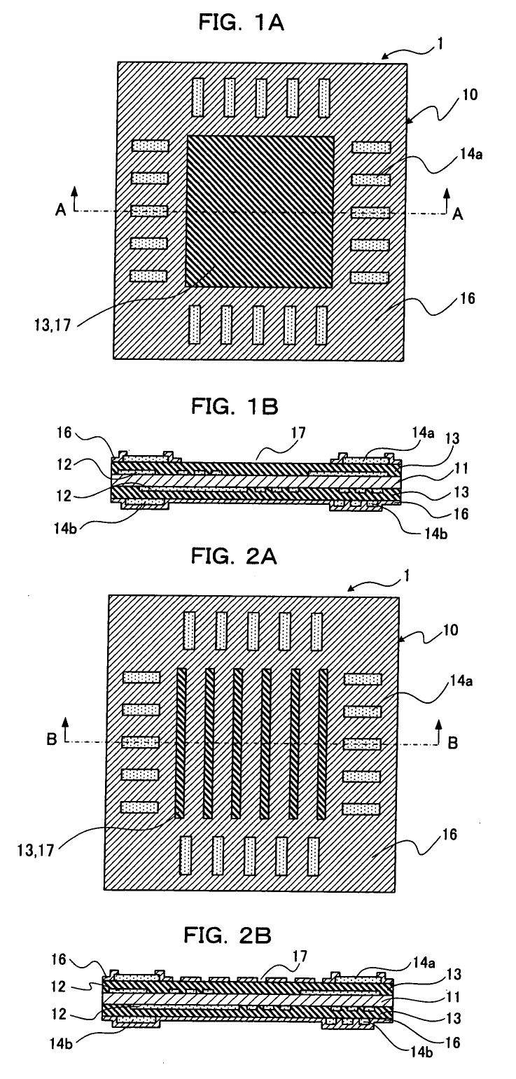

First, referring to FIGS. 1A and 1B, the configuration of the printed wiring board will be described below.

In a mounting area 10 of a printed wiring board 1 according to First Embodiment, conductor wiring layers (inner layers) 12 are provided on both sides of a core substrate 11, and the surfaces of the conductor wiring layers 12 are covered with interlayer insulating resin layers 13. Further, a conductor wiring layer (outer layer) 14b and a plurality of conductor lands (conductor land portions) 14a for mounting (solder and the like) a semiconductor device are provided on the surfaces of the interlayer insulating resin layer 13, and surface insulating resin layers 16 are provided on the outermost surfaces (outside surfaces). Therefore, one side of the printed wiring board 1 has a four-layer structure (four-layer board). The conductor lands 14a are disposed on the periphery (edge) of the mounting area 10. FIG. 1A shows the mounting area 10 of the semiconductor device of surface mount lead type typified by QFP and QFN.

The thickness of the overall printed wiring board 1 is mainly set at 0.4 mm to 1.6 mm and the number of layers is at least 1 to 10 (the number of layers is not limited and FIGS. 1A and 1B show four layers).

As the core substrate 11 and the interlayer insulating resin layer 13, a reinforcing base such as a paper base, a glass base, a glass nonwoven fabric base, and an aramid nonwoven fabric base is frequently impregnated with phenol resin, epoxy resin, polyimide resin, bismaleimide-triazine resin, and so on.

The conductor wiring layers (inner layers) 12, the conductor wiring layer (outer layer) 14b, and the conductor lands 14a are generally made of Cu. These layers and lands are formed by a method of forming wiring by copper foil etching and a method of forming wiring by Cu plating. Further, each layer is about 10 μm to 40 μm in thickness and the inner layer is generally thinner than the outer layer.

Surface treatment on the conductor lands 14a is one of the application of heat resistant pre-flux and the plating of Ni, Pd, Au and the like, so that the solderability improves. Moreover, as the surface insulating resin layer 16, a photosensitive resin called solder resist is frequently used with a thickness of about 10 μm to 40 μm.

The conductor wiring layers (inner layers) 12, the conductor wiring layer (outer layer) 14b, and the conductor lands 14a are connected to one another via through holes, via holes, and so on (not shown) to form a predetermined (desired) circuit.

Moreover, in the mounting area 10 of the printed wiring board 1, the surface insulating resin layer 16 is removed like a quadrilateral (e.g., a square), that is, a quadrilateral removed portion 17 is formed and the interlayer insulating resin layer 13 under the removed portion 17 is exposed in an area (central portion) other than the conductor lands 14a and immediately below the semiconductor device, the conductor lands 14a being disposed on the edge of the mounting area 10.

The method of manufacturing the printed wiring board 1 will be schematically described below.

To be specific, this manufacturing method is a method of manufacturing a printed wiring board having one of a single-layer structure and a multilayer structure, the method including the steps of: obtaining the conductor wiring layer by forming a wiring pattern on the conductor layer provided on at least one side of the core substrate; and forming the surface insulating resin layer on the conductor wiring layer on the outermost surface after repeatedly performing a predetermined number of times the steps of forming the interlayer insulating resin layer so as to cover the conductor wiring layer and forming the conductor wiring layer on the interlayer insulating resin layer, wherein the method further includes the step of forming, in the area for mounting the semiconductor device, the surface insulating resin layer and selectively removing a part of the surface insulating resin layer in the area other than the conductor land portions and immediately below the semiconductor device, the conductor land portions being bonded to the external electrodes of the semiconductor device.

Further, a single-layer structure is also included in the description of this manufacturing method and thus this manufacturing method is also applicable to a printed wiring board having a single-layer structure (in this case, the predetermined number of repetitions is one and the application of a single-layer structure similarly holds for embodiments described below).

According to the printed wiring board and the method of manufacturing the same, the central portion of the surface insulating resin layer 16 is removed like a quadrilateral, and thus an area on which the surface insulating resin layer 16 expands becomes quite small, thereby preventing a surface of the wiring board from coming into contact with the backside of the semiconductor device during reflow heating when a semiconductor device is mounted.

Although the removed portion 17 is shaped like a square in FIGS. 1A and 1B, the removed portion 17 may be a rectangle, a polygon, and a circle as long as an area on which the surface insulating resin layer 16 expands is removed.

### Second Embodiment

Referring to FIGS. 2A and 2B, a printed wiring board and a method of manufacturing the same will be described below according to Second Embodiment of the present invention (corresponding to claim 1 and claim 15).

In First Embodiment, the surface insulating resin layer 16 on the interlayer insulating resin layer 13 is removed like a quadrilateral, whereas in Second Embodiment, a surface insulating resin layer 16 is removed like slits and the other configurations are identical to those of First Embodiment. Thus the different part will be mainly described below. The same constituent elements as those of First Embodiment are indicated by the same reference numerals and the explanation thereof is omitted.

As shown in FIGS. 2A and 2B, in a mounting area 10 of a printed wiring board 1, the surface insulating resin layer 16 is removed like slits (also like strips), that is, a plurality of slit-like removed portions 17 are formed and an interlayer insulating resin layer 13 under the removed portions 17 is exposed in an area (central portion) other than a plurality of conductor lands (conductor land portions) 14a and immediately below a semiconductor device, the conductor lands 14a being disposed on the edge of the mounting area 10.

With this configuration, an area on which the surface insulating resin layer 16 expands is divided to reduce an amount of expansion of the surface insulating resin layer 16, so that during reflow heating when a semiconductor device is mounted, it is possible to prevent a surface of the wiring board, that is, the surface insulating resin layer 16 from coming into contact with the backside of the semiconductor device.

The method of manufacturing the printed wiring board 1 according to Second Embodiment is the same as that of First Embodiment and thus the explanation thereof is omitted.

### Third Embodiment

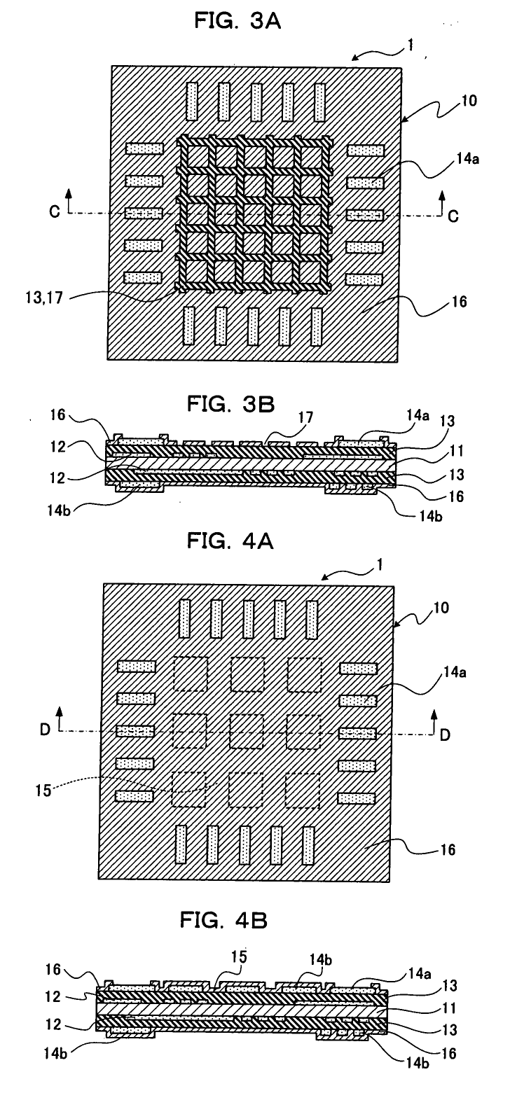

Referring to FIGS. 3A and 3B, a printed wiring board and a method of manufacturing the same will be described below according to Third Embodiment of the present invention (corresponding to claim 1 and claim 15).

In First Embodiment, the surface insulating resin layer 16 on the interlayer insulating resin layer 13 is removed like a quadrilateral, whereas in Third Embodiment, a surface insulating resin layer 16 is removed in a gridlike fashion and the other configurations are identical to those of First Embodiment. Thus the different part will be mainly described below. The same constituent elements as those of First Embodiment are indicated by the same reference numerals and the explanation thereof is omitted.

As shown in FIGS. 3A and 3B, in a mounting area 10 of a printed wiring board 1, the surface insulating resin layer 16 is removed in a grid-like fashion like grooves having a predetermined width, that is, a grid-like removed portion (also referred to as a groove portion) 17 is formed and an interlayer insulating resin layer 13 under the removed portion 17 is exposed in an area (central portion) other than a plurality of conductor lands (conductor land portions) 14a and immediately below a semiconductor device, the conductor lands being disposed on the edge of the mounting area 10.

With this configuration, as in Second Embodiment, an area on which the surface insulating resin layer 16 expands is divided to reduce an amount of expansion of the surface insulating resin layer 16, so that during reflow heating when a semiconductor device is mounted, it is possible to prevent a surface of the wiring board, that is, the surface insulating resin layer 16 from coming into contact with the backside of the semiconductor device.

The method of manufacturing the printed wiring board 1 according to Third Embodiment is also the same as that of First Embodiment and thus the explanation thereof is omitted.

In one of Second and Third Embodiments, the removed portion is shaped like vertical slits or formed in a grid-like fashion. The shape of the removed portion may be horizontal or diagonal slits and a diagonal mesh. Further, it is not necessary to unify the dimensions and angles of these slits, grid, and mesh.

The configuration of one of Second and Third Embodiments is effective when the hygroscopicity and reliability of the printed wiring board are adversely affected and the configuration of First Embodiment is not applicable.

### Fourth Embodiment

Referring to FIGS. 4A and 4B, a printed wiring board and a method of manufacturing the same will be described below according to Fourth Embodiment of the present invention (corresponding to claim 3, claim 5, and claim 16).

In First Embodiment, the surface insulating resin layer 16 on the interlayer insulating resin layer 13 is removed like a quadrilateral, whereas in Fourth Embodiment, a conductor wiring layer 14b formed under a surface insulating resin layer 16 is partially removed and the other configurations are identical to those of First Embodiment. Thus the different part will be mainly described below. The same constituent elements as those of First Embodiment are indicated by the same reference numerals and the explanation thereof is omitted.

As shown in FIGS. 4A and 4B, in a mounting area 10 of a printed wiring board 1, the conductor wiring layer (outer layer) 14b formed under the surface insulating resin layer 16 is removed in a grid-like fashion like grooves having a predetermined width in an area (central portion) other than a plurality of conductor lands (conductor land portions) 14a and immediately below a semiconductor device, the conductor lands 14a being disposed on the edge of the mounting area 10. In other words, a removed portion 15 is formed in a grid-like fashion on the conductor wiring layer 14b, so that the plurality of (3×3=9 in FIG. 4A) conductor wiring layers 14b are separately formed (divided) like, for example, squares.

With this configuration, the surface insulating resin layer 16 on the conductor wiring layer (outer layer) 14b is neither even nor flat. The surface insulating resin layer 16 is recessed (recessed portions are formed) by the removed portion 15 and is seemingly divided like the conductor wiring layers (outer layer) 14b.

Therefore, an area on which the surface insulating resin layer 16 expands is divided to reduce an amount of expansion of the surface insulating resin layer 16, so that during reflow heating when a semiconductor device is mounted, it is possible to prevent a surface of the wiring board, that is, the surface insulating resin layer 16 from coming into contact with the backside of the semiconductor device.

The configuration and manufacturing method of the printed wiring board 1 will be schematically described below.

To be specific, the printed wiring board is one of a single-layer printed wiring board and a multilayer printed wiring board in which the conductor wiring layer and the interlayer insulating resin layer are stacked or alternately stacked on at least one side of a core substrate and the conductor wiring layer on the outermost surface is covered with the surface insulating resin layer, wherein in an area for mounting a semiconductor device, a part of the conductor wiring layer on the outermost surface is selectively removed and the surface insulating resin layer formed on the removed area (removed portion) is recessed in an area other than the conductor land portions and immediately below the semiconductor device, the conductor land portions being bonded to the external electrodes of the semiconductor device.

Moreover, the manufacturing method is a method of manufacturing a printed wiring board having one of a single-layer structure and a multilayer structure, the method including the steps of: obtaining the conductor wiring layer by forming a wiring pattern on the conductor layer provided on at least one side of the core substrate; and forming the surface insulating resin layer on the conductor wiring layer on the outermost surface after repeatedly performing a predetermined number of times the steps of forming the interlayer insulating resin layer so as to cover the conductor wiring layer and forming the conductor wiring layer on the interlayer insulating resin layer, wherein the method further includes the step of forming, in the area for mounting the semiconductor device, the conductor wiring layer on the outermost surface and selectively removing a part of the conductor wiring layer on the outermost surface in the area other than the conductor land portions and immediately below the semiconductor device, the conductor land portions being bonded to the external electrodes of the semiconductor device.

### Fifth Embodiment

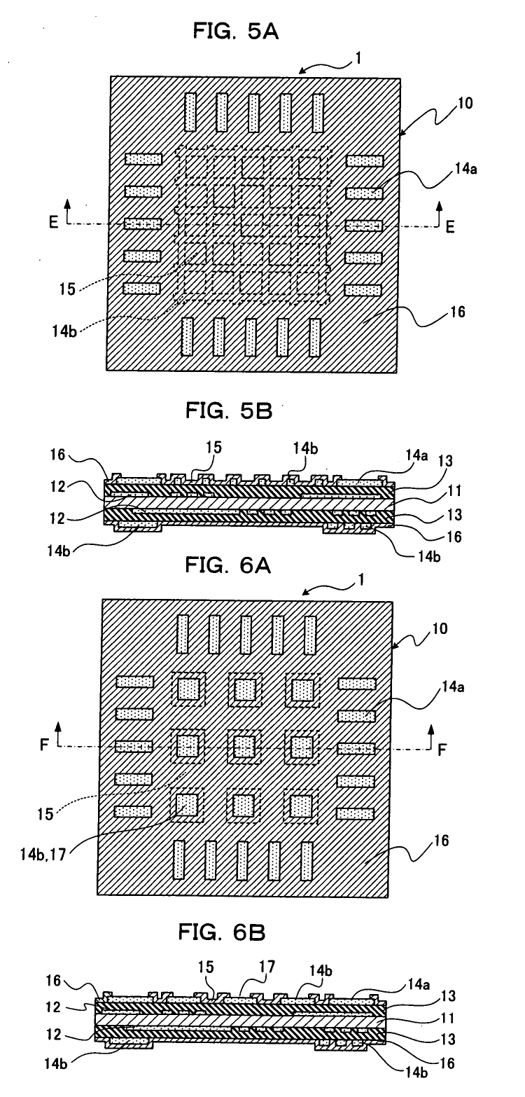

Referring to FIGS. 5A and 5B, a printed wiring board and a method of manufacturing the same will be described below according to Fifth Embodiment of the present invention (corresponding to claim 3 and claim 8 and claim 16).

In Fourth Embodiment, the conductor wiring layer 14b on the interlayer insulating resin layer 13 is removed in a grid-like fashion like grooves having a predetermined width. Conversely, in Fifth Embodiment, a conductor wiring layer 14b formed under a surface insulating resin layer 16 is formed in a grid-like fashion. Since the other configurations are identical to those of Fourth Embodiment, the different part will be mainly described below. The same constituent elements as those of Fourth Embodiment (that is, First Embodiment) are indicated by the same reference numerals and the explanation thereof is omitted.

As shown in FIGS. 5A and 5B, in a mounting area 10 of a printed wiring board 1, the conductor wiring layer (outer layer) 14b under the surface insulating resin layer 16 is formed in a grid-like fashion in an area (central portion) other than a plurality of conductor lands (conductor land portions) 14a and immediately below a semiconductor device, the conductor lands 14a being disposed on the edge of the mounting area 10. In other words, a plurality of removed portions 15 (5×5=25 removed portions are formed in FIG. 5A) are vertically and horizontally formed on the conductor wiring layer 14b.

With this configuration, the same effect as Fourth Embodiment can be obtained.

In Fourth Embodiment, the conductor wiring layer (outer layer) 14b is shaped like a square. The conductor wiring layer 14b may be rectangular, polygonal, and circular.

Although the conductor wiring layer (outer layer) 14b is formed in a grid-like fashion in Fifth Embodiment, the conductor wiring layer 14b may be shaped like slits and a diagonal mesh. It is not necessary to unify the dimensions and angles of the slits, grid, and mesh. Further, the conductor wiring layer (outer layer) 14b may be dummy wiring not electrically connected to the semiconductor device, that is, conductor lands 14a (corresponding to claims 4 and 7).

Fourth and Fifth Embodiments are effective, for example, when it is necessary to improve heat dissipation and electrical characteristics more than First to Third Embodiments.

### Sixth Embodiment

Referring to FIGS. 6A and 6B, a printed wiring board and a method of manufacturing the same will be described below according to Sixth Embodiment of the present invention (corresponding to claim 6 and claim 17).

In Fourth Embodiment, the conductor wiring layer 14b formed on the interlayer insulating resin layer 13 and under the surface insulating resin layer 16 is removed in a grid-like fashion, whereas in Sixth Embodiment, a part of a surface insulating resin layer 16 is further removed on a plurality of conductor wiring layers 14b formed inside a grid-like pattern and the other configurations are identical to those of Fourth Embodiment. Thus the different part will be mainly described below. The same constituent elements as those of Fourth Embodiment are indicated by the same reference numerals and the explanation thereof is omitted.

As shown in FIGS. 6A and 6B, in a mounting area 10 of a printed wiring board 1, the conductor wiring layer (outer layer) 14b formed under the surface insulating resin layer 16 is removed in a grid-like fashion with a predetermined width and the surface insulating resin layer 16 is removed like squares on the plurality of conductor wiring layers 14b having been formed into, for example, squares inside a grid-like pattern (of course, the surface insulating resin layer 16 may be removed like quadrilaterals other than squares) in an area (central portion) other than a plurality of conductor lands (conductor land portions) 14a and immediately below a semiconductor device, the conductor lands 14a being disposed on the edge of the mounting area 10. In other words, a grid-like removed portion (groove portion) 15 is formed on the conductor wiring layer 14b, and removed portions 17 shaped like squares (quadrilaterals) are formed on the surface insulating resin layer 16 on the conductor wiring layers 14b formed inside the removed portion 15.

With this configuration, the area of the surface insulating resin layer 16 on the conductor wiring layers 14b is minimized. Thus an amount of expansion can be reduced more than Fourth Embodiment, and during reflow heating when a semiconductor device is mounted, it is possible to prevent a surface of the wiring board from coming into contact with the backside of the semiconductor device. Further, the conductor wiring layer (outer layer) 14b may be dummy wiring not electrically connected to the semiconductor device, that is, conductor lands 14a (corresponding to claims 4 and 7).

The configuration and manufacturing method of a printed wiring board 1 will be schematically described below.

To be specific, the printed wiring board is one of a single-layer printed wiring board and a multilayer printed wiring board in which the conductor wiring layer and the interlayer insulating resin layer are stacked or alternately stacked on at least one side of a core substrate and the outermost conductor wiring layer is covered with the surface insulating resin layer, wherein in an area for mounting a semiconductor device, a part of the surface insulating resin layer formed on one of the interlayer insulating resin layer and the conductor wiring layer and a part of the outermost conductor wiring layer are selectively removed in an area other than the conductor land portions and immediately below the semiconductor device, the conductor land portions being bonded to the external electrodes of the semiconductor device.

Further, the manufacturing method is a method of manufacturing a printed wiring board having one of a single-layer structure and a multilayer structure, the method including the steps of: obtaining the conductor wiring layer by forming a wiring pattern on the conductor layer provided on at least one side of the core substrate; and forming the surface insulating resin layer on the outermost conductor wiring layer after repeatedly performing a predetermined number of times the steps of forming the interlayer insulating resin layer so as to cover the conductor wiring layer and forming the conductor wiring layer on the interlayer insulating resin layer, wherein the method further includes the steps of forming, in an area for mounting the semiconductor device, the surface insulating resin layer and selectively removing a part of the surface insulating resin layer in an area other than the conductor land portions and immediately below the semiconductor device, the conductor land portions being bonded to the external electrodes of the semiconductor device; and forming the outermost conductor wiring layer and selectively removing a part of the outermost conductor wiring layer.

A method of manufacturing the printed wiring board according to Sixth Embodiment will be specifically described later.

### Seventh Embodiment

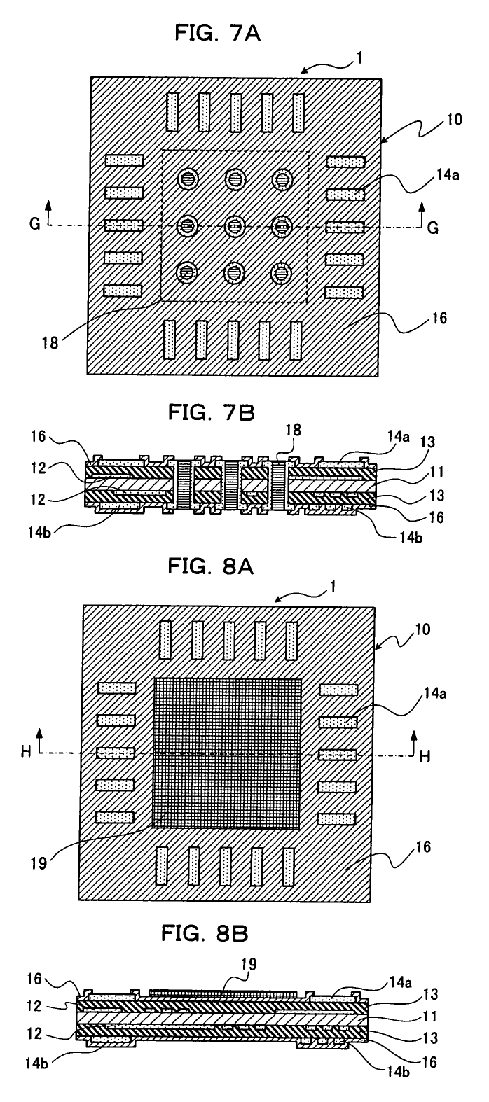

Referring to FIGS. 7A and 7B, a printed wiring board and a method of manufacturing the same will be described below according to Seventh Embodiment of the present invention (corresponding to claim 9 and claim 18).

In First Embodiment, the surface insulating resin layer 16 on the interlayer insulating resin layer 13 is removed like a quadrilateral, whereas in Seventh Embodiment, through holes or via holes are formed inside conductor lands. The other configurations are identical to those of First Embodiment and thus the different part will be mainly described below. The same constituent elements as those of First Embodiment are indicated by the same reference numerals and the explanation thereof is omitted.

As shown in FIGS. 7A and 7B, in a mounting area 10 of a printed wiring board 1, a plurality of through holes 18 are formed to connect wiring on the positions of lattice points in a grid-like pattern in an area (central portion) other than a plurality of conductor lands (conductor land portions) 14a and immediately below a semiconductor device, the conductor lands 14a being disposed on the edge of the mounting area 10.

Since a surface insulating resin layer 16 is not formed on the through holes 18 in this configuration, an area on which the surface insulating resin layer 16 expands is divided and an amount of expansion can be reduced.

The through holes 18 may be dummy wiring not electrically connected to a semiconductor device and via holes may be formed instead of the through holes (corresponding to claim 10).

The configuration and manufacturing method of the printed wiring board 1 will be schematically described below.

To be specific, the printed wiring board is one of a single-layer printed wiring board and a multilayer printed wiring board in which the conductor wiring layer and the interlayer insulating resin layer are stacked or alternately stacked on at least one side of a core substrate and the outermost conductor wiring layer is covered with the surface insulating resin layer, wherein in an area for mounting a semiconductor device, ones of a plurality of through holes and a plurality of via holes are formed in an area other than the conductor land portions and immediately below the semiconductor device, the conductor land portions being bonded to the external electrodes of the semiconductor device.

Further, the manufacturing method is a method of manufacturing a printed wiring board having one of a single-layer structure and a multilayer structure, the method including the steps of: obtaining the conductor wiring layer by forming a wiring pattern on the conductor layer provided on at least one side of the core substrate; and forming the surface insulating resin layer on the outermost conductor wiring layer after repeatedly performing a predetermined number of times the steps of forming the interlayer insulating resin layer so as to cover the conductor wiring layer and forming the conductor wiring layer on the interlayer insulating resin layer, wherein the method further includes the step of forming, in an area for mounting the semiconductor device, one of a through hole and a via hole in an area other than the conductor land portions and immediately below the semiconductor device before the step of forming the surface insulating resin layer, the conductor land portions being bonded to the external electrodes of the semiconductor device.

### Eighth Embodiment

Referring to FIGS. 8A and 8B, a printed wiring board and a method of manufacturing the same will be described below according to Eighth Embodiment of the present invention (corresponding to claim 11, claim 12, claim 13, claim 14, and claim 19).

In First Embodiment, the surface insulating resin layer 16 on the interlayer insulating resin layer 13 is removed like a quadrilateral, whereas in Eighth Embodiment, another surface insulating resin layer is formed on a surface insulating resin layer and the other configurations are identical to those of First Embodiment. Thus the different part will be mainly described below. The same constituent elements as those of First Embodiment are indicated by the same reference numerals and the explanation thereof is omitted.

As shown in FIGS. 8A and 8B, in a mounting area 10 of a printed wiring board 1, a second surface insulating resin layer 19 is formed on a first surface insulating resin layer 16 in an area (central portion) other than a plurality of conductor lands (conductor land portions) 14a and immediately below a semiconductor device, the conductor lands 14a being disposed on the edge of the mounting area 10.

The second surface insulating resin layer 19 has a lower coefficient of thermal expansion than the first surface insulating resin layer 16 formed under the second surface insulating resin layer 19. As the first surface insulating resin layer 16, a photoresist called a solder resist is frequently used. As the second surface insulating resin layer 19, a solder resist (having a low coefficient of thermal expansion) is used as in the first surface insulating resin layer 16. Alternatively, a thermosetting resin containing a filler, a metal thin film, and so on are used as the second surface insulating resin layer 19.

As described above, since the second surface insulating resin layer 19 having a low coefficient of thermal expansion is formed on the first surface insulating resin layer 16, it is possible to reduce the amount of expansion of the surface insulating resin layer 16 formed under the second surface insulating resin layer 19. Therefore, during reflow heating when a semiconductor device is mounted, it is possible to prevent a surface of the wiring board from coming into contact with the backside of the semiconductor device.

The configuration and manufacturing method of the printed wiring board 1 will be schematically described below.

The printed wiring board is one of a single-layer printed wiring board and a multilayer printed wiring board in which the conductor wiring layer and the interlayer insulating resin layer are stacked or alternately stacked on at least one side of a core substrate and the outermost conductor wiring layer is covered with the surface insulating resin layer, wherein in an area for mounting a semiconductor device, the second surface insulating resin layer is formed on the first surface insulating resin layer in an area other than the conductor land portions and immediately below the semiconductor device, the conductor land portions being bonded to the external electrodes of the semiconductor device, and the second surface insulating resin layer has a lower coefficient of thermal expansion than the first surface insulating resin layer.

Further, the manufacturing method is a method of manufacturing a printed wiring board having one of a single-layer structure and a multilayer structure, the method including the steps of: obtaining the conductor wiring layer by forming a wiring pattern on the conductor layer provided on at least one side of the core substrate; and forming the first surface insulating resin layer on the outermost conductor wiring layer after repeatedly performing a predetermined number of times the steps of forming the interlayer insulating resin layer so as to cover the conductor wiring layer and forming the conductor wiring layer on the interlayer insulating resin layer, wherein the method further includes the step of forming, in an area for mounting the semiconductor device, the second surface insulating resin layer on the first surface insulating resin layer in an area other than the conductor land portions and immediately below the semiconductor device, the conductor land portions being bonded to the external electrodes of the semiconductor device, and the second surface insulating resin layer has a lower coefficient of thermal expansion than the first surface insulating resin layer.

Although the second surface insulating resin layer 19 is formed on the first surface insulating resin layer 16 in Eighth Embodiment, the second surface insulating resin layer 19 may be formed on the removed portions 17 and 15 described in First to Third Embodiments (corresponding to claim 12, claim 14, and claim 20).

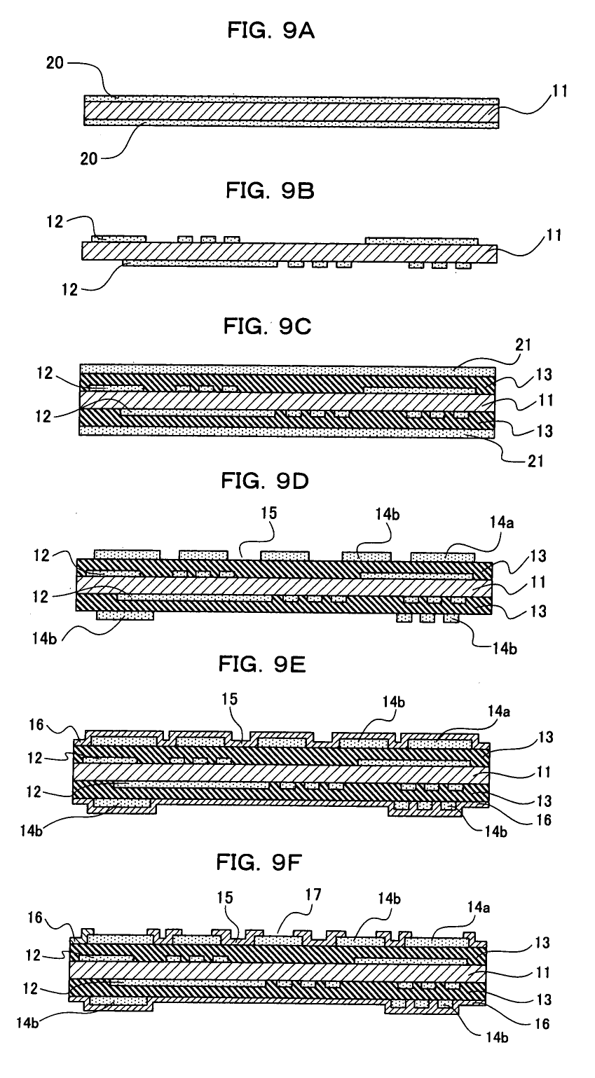

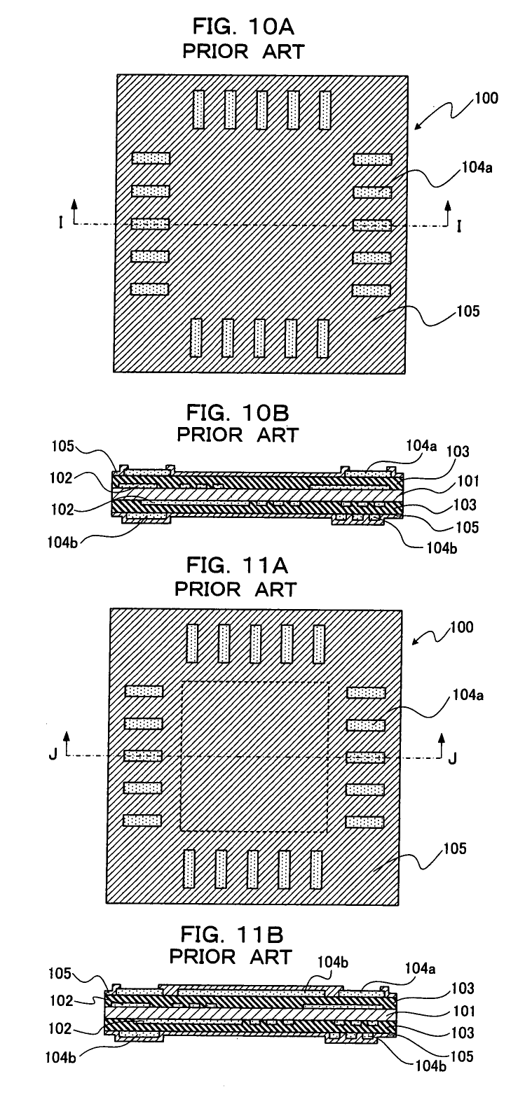

Finally, referring to FIGS. 9A to 9F, a method of manufacturing the printed wiring board according to Sixth Embodiment will be specifically described below.

First, as shown in FIG. 9A, conductor layers (inner layers) 20 are bonded to both sides of a core substrate 11, and then the conductor layers 20 are brought into intimate contact and cured by thermocompression bonding. As the core substrate 11, a reinforcing base such as a paper base, a glass base, a glass nonwoven fabric base, and an aramid nonwoven fabric base is frequently used. The reinforcing base is impregnated with one of phenol resin, epoxy resin, polyimide resin, and bismaleimide-triazine resin, and then is dried and semi-cured. Further, the conductor layer (inner layer) 20 is generally Cu foil having a thickness of about 10 μm to 40 μm. The conductor layer (inner layer) 20 is boned only to a surface requiring conductor wiring. Thus, for example, in the case of a single-layer substrate, the conductor layer 20 is bonded only to one side of the core substrate 11. In the case of a multilayer substrate, the conductor layers 20 are bonded to both sides of the core substrate 11.

Next, as shown in FIG. 9B, an etching resist is applied to the surfaces of the conductor layers (inner layers) 20, patterns are formed thereon by exposure and development, and then the conductor layers (inner layers) 20 are etched, so that conductor wiring layers (inner layer) 12 are formed.

After that, as shown in FIG. 9C, interlayer insulating resin layers 13 and conductor layers (outer layers) 21 are disposed on both sides of the core substrate 11 on which the conductor wiring layers (inner layers) 12 have been formed, and then the layers are bonded by thermocompression bonding in an overlapping state. In this case, as the interlayer insulating resin layer 13, a reinforcing base such as a paper base, a glass base, a glass nonwoven fabric base, and an aramid nonwoven fabric base is frequently used as in the core substrate 11. The reinforcing base is impregnated with phenol resin, epoxy resin, polyimide resin, bismaleimide-triazine resin, and so on. Further, the conductor layer (outer layer) 21 is Cu foil having a thickness of about 10 μm to 40 μm as in the conductor layer (inner layer) 20.

Next, as shown in FIG. 9D, an etching resist is applied to the surfaces of the conductor layers (outer layers) 21, patterns are formed thereon by exposure and development, and then the conductor layers (outer layers) 21 are etched, so that conductor lands 14a and a conductor wiring layer (outer layer) 14b for mounting (joining) a semiconductor device are formed. At this moment, in the mounting area 10 of the semiconductor device, the conductor layers (outer layers) 21 are removed in a grid-like fashion with a predetermined width in an area other than the conductor lands 14a and immediately below the semiconductor device. The conductor layer (outer layer) 21 is divided into a plurality of conductor wiring layers (outer layers) 14b by removed portions 15.

Next, as shown in FIG. 9E, the surface insulating resin layer 16 is applied over the conductor lands 14a and the conductor wiring layers 14b on both sides of the interlayer insulating resin layers 13 by one of a roller coater and a spin coater, and then the surface insulating resin layer 16 is dried. In the case of a single-layer substrate, the surface insulating resin layer 16 may be applied only to one side by curtain coating.

After that, as shown in FIG. 9F, the surface insulating resin layer 16 is exposed using a photomask, and then the surface insulating resin layer 16 is developed, so that openings are formed on the conductor lands 14a. At this moment, in the mounting area 10 of the semiconductor device, the surface insulating resin layer 16 on the conductor wiring layers (outer layers) 14b is partially removed (removed portions 17) in an area other than the conductor lands 14a and immediately below the semiconductor device.

According to this manufacturing method, in the mounting area 10 for a semiconductor device, the conductor wiring layer (outer layer) 14b is divided by removing the conductor wiring layer 14b in a grid-like fashion (removed portions 15) in the area other than the conductor lands 14a and immediately below the semiconductor device, so that the surface insulating resin layer 16 on the conductor wiring layer (outer layer) 14b is neither even nor flat. Since recessed portions 16a are formed by the removed portions 15, the surface insulating resin layer 16 is also seemingly divided like the conductor wiring layer (outer layer) 14b. Further, since the area of the surface insulating resin layer 16 on the conductor wiring layer 14b is also minimized, the amount of expansion of the surface insulating resin layer 16 is reduced, and during reflow heating when a semiconductor device is mounted, it is possible to prevent a surface of the wiring board from coming into contact with the backside of the semiconductor device, thereby improving yields and the quality and reliability of a mounting operation. The above manufacturing method was described by taking a laminated substrate as an example and is also applicable to a variety of printed substrates such as a built-up substrate.

### INDUSTRIAL APPLICABILITY

A printed wiring board and a method of manufacturing the same according to the present invention can improve the quality and reliability of a mounting operation in high-density packaging. Thus the present invention is suitable for the miniaturization, thickness reduction, and improvement in functionality of information communications equipment, office electronic equipment, and so on.

What is claimed is:

1. A printed wiring board having one of a single-layer structure and a multi-layer structure in which a conductor wiring layer and an interlayer insulating resin layer are stacked or alternately stacked on at least one side of a core substrate and the outermost conductor wiring layer is covered with a surface insulating resin layer,
wherein in an area for mounting a semiconductor device, a part of the surface insulating resin layer formed on one of the interlayer insulating resin layer and the conductor wiring layer is removed in an area other than conductor land portions and immediately below the semiconductor device, the conductor land portions being bonded to external electrodes of the semiconductor device.

2. The printed wiring board according to claim 1, wherein the conductor wiring layer other than the conductor land portions formed in the area immediately below the semiconductor device is dummy wiring not electrically connected to the conductor land portions.

3. A printed wiring board having one of a single-layer structure and a multilayer structure in which a conductor wiring layer and an interlayer insulating resin layer are stacked or alternately stacked on at least one side of a core substrate and the outermost conductor wiring layer is covered with a surface insulating resin layer,
wherein in an area for mounting a semiconductor device, a part of the outermost conductor wiring layer is removed in an area other than conductor land portions and immediately below the semiconductor device, the conductor land portions being bonded to external electrodes of the semiconductor device.

4. The printed wiring board according to claim 3, wherein the conductor wiring layer other than the conductor land portions formed in the area immediately below the semiconductor device is dummy wiring not electrically connected to the conductor land portions.

5. The printed wiring board according to claim 3, wherein the surface insulating resin layer is recessed in the area on which the part of the conductor wiring layer is removed.

6. A printed wiring board having one of a single-layer structure and a multilayer structure in which a conductor wiring layer and an interlayer insulating resin layer are stacked or alternately stacked on at least one side of a core substrate and the outermost conductor wiring layer is covered with a surface insulating resin layer,
wherein in an area for mounting a semiconductor device, a part of the surface insulating resin layer formed on one of the interlayer insulating resin layer and the conductor wiring layer and a part of the outermost conductor wiring layer are removed in an area other than conductor land portions and immediately below the semiconductor device, the conductor land portions being bonded to external electrodes of the semiconductor device.

7. The printed wiring board according to claim 6, wherein the conductor wiring layer other than the conductor land portions formed in the area immediately below the semiconductor device is dummy wiring not electrically connected to the conductor land portions.

8. The printed wiring board according to claim 6, wherein the surface insulating resin layer is recessed on the area on which the part of the conductor wiring layer is removed.

9. A printed wiring board having one of a single-layer structure and a multilayer structure in which a conductor wiring layer and an interlayer insulating resin layer are stacked or alternately stacked on at least one side of a core substrate and the outermost conductor wiring layer is covered with a surface insulating resin layer,
wherein in an area for mounting a semiconductor device, ones of a plurality of through holes and a plurality of via holes are formed in an area other than conductor land portions and immediately below the semiconductor device, the conductor land portions being bonded to external electrodes of the semiconductor device.

10. The printed wiring board according to claim 9, wherein one of the through hole and the via hole is dummy wiring not electrically connected to the conductor land portions.

11. A printed wiring board having one of a single-layer structure and a multilayer structure in which a conductor wiring layer and an interlayer insulating resin layer are stacked or alternately stacked on at least one side of a core substrate and the outermost conductor wiring layer is covered with a first surface insulating resin layer,
wherein in an area for mounting a semiconductor device, a second surface insulating resin layer is formed on the first surface insulating resin layer in an area other than conductor land portions and immediately below the semiconductor device, the conductor land portions being bonded to external electrodes of the semiconductor device.

12. A printed wiring board having one of a single-layer structure and a multilayer structure in which a conductor wiring layer and an interlayer insulating resin layer are stacked or alternately stacked on at least one side of a core substrate and the outermost conductor wiring layer is covered with a first surface insulating resin layer,
wherein in an area for mounting a semiconductor device, a part of the first surface insulating resin layer is removed and a second surface insulating resin layer is formed on the removed part in an area other than conductor land portions and immediately below the semiconductor device, the conductor land portions being bonded to external electrodes of the semiconductor device.

13. The printed wiring board according to claim 11, wherein the second surface insulating resin layer has a lower coefficient of thermal expansion than the first surface insulating resin layer.

14. The printed wiring board according to claim 12, wherein the second surface insulating resin layer has a lower coefficient of thermal expansion than the first surface insulating resin layer.

15. A method of manufacturing a printed wiring board having one of a single-layer structure and a multilayer structure, the method comprising:
obtaining a conductor wiring layer by forming a wiring pattern on a conductor layer provided on at least one side of a core substrate; and
forming a surface insulating resin layer on the outermost conductor wiring layer after repeatedly performing a predetermined number of times forming an interlayer insulating resin layer so as to cover the conductor wiring layer and forming a conductor wiring layer on the interlayer insulating resin layer,
wherein the method further comprises forming, in an area for mounting a semiconductor device, the surface insulating resin layer and removing a part of the surface insulating resin layer in an area other than conductor land portions and immediately below the semiconductor device, the conductor land portions being bonded to external electrodes of the semiconductor device.

16. A method of manufacturing a printed wiring board having one of a single-layer structure and a multilayer structure, the method comprising:
obtaining a conductor wiring layer by forming a wiring pattern on a conductor layer provided on at least one side of a core substrate; and
forming a surface insulating resin layer on the outermost conductor wiring layer after repeatedly performing a predetermined number of times forming an interlayer insulating resin layer so as to cover the conductor wiring layer and forming a conductor wiring layer on the interlayer insulating resin layer,
wherein the method further comprises forming, in an area for mounting a semiconductor device, the outermost conductor wiring layer and removing a part of the outermost conductor wiring layer in an area other than conductor land portions and immediately below the semiconductor device, the conductor land portions being bonded to external electrodes of the semiconductor device.

17. A method of manufacturing a printed wiring board having one of a single-layer structure and a multilayer structure, the method comprising:
obtaining a conductor wiring layer by forming a wiring pattern on a conductor layer provided on at least one side of a core substrate; and
forming a surface insulating resin layer on the outermost conductor wiring layer after repeatedly performing a predetermined number of times forming an interlayer insulating resin layer so as to cover the conductor wiring layer and forming a conductor wiring layer on the interlayer insulating resin layer,
wherein the method further comprises: forming, in an area for mounting a semiconductor device, the surface insulating resin layer and removing a part of the surface insulating resin layer in an area other than conductor land portions and immediately below the semiconductor device, the conductor land portions being bonded to external electrodes of the semiconductor device; and forming the outermost conductor wiring layer and removing a part of the outermost conductor wiring layer.

18. A method of manufacturing a printed wiring board having one of a single-layer structure and a multilayer structure, the method comprising:
obtaining a conductor wiring layer by forming a wiring pattern on a conductor layer provided on at least one side of a core substrate; and
forming a surface insulating resin layer on the outermost conductor wiring layer after repeatedly performing a predetermined number of times forming an interlayer insulating resin layer so as to cover the conductor wiring layer and forming a conductor wiring layer on the interlayer insulating resin layer,
wherein the method further comprises forming, in an area for mounting a semiconductor device, one of a through hole and a via hole in an area other than conductor land portions and immediately below the semiconductor device before forming the surface insulating resin layer, the conductor land portions being bonded to external electrodes of the semiconductor device.

19. A method of manufacturing a printed wiring board having one of a single-layer structure and a multilayer structure, the method comprising:
obtaining a conductor wiring layer by forming a wiring pattern on a conductor layer provided on at least one side of a core substrate; and
forming a first surface insulating resin layer on the outermost conductor wiring layer after repeatedly performing a predetermined number of times forming an interlayer insulating resin layer so as to cover the conductor wiring layer and forming a conductor wiring layer on the interlayer insulating resin layer,
wherein the method further comprises forming, in an area for mounting a semiconductor device, a second surface insulating resin layer on the first surface insulating resin layer in an area other than conductor land portions and immediately below the semiconductor device, the conductor land portions being bonded to external electrodes of the semiconductor device.

20. A method of manufacturing a printed wiring board having one of a single-layer structure and a multilayer structure, the method comprising:
obtaining a conductor wiring layer by forming a wiring pattern on a conductor layer provided on at least one side of a core substrate; and
forming a first surface insulating resin layer on the outermost conductor wiring layer after repeatedly performing a predetermined number of times forming an interlayer insulating resin layer so as to cover the conductor wiring layer and forming a conductor wiring layer on the interlayer insulating resin layer,
wherein the method further comprises forming, in an area for mounting a semiconductor device, the first surface insulating resin layer, removing a part of the first surface insulating resin layer, and forming a second surface insulating resin layer on the removed part in an area other than conductor land portions and immediately below the semiconductor device, the conductor land portions being bonded to the external electrodes of the semiconductor device.
